(19) United States
(12) Patent Application Publication
(10) Pub. No.: US 2017/0129160 A1
(43) Pub. Date: May 11, 2017

(54) DOOR SAFETY SHIELD AND METHODS OF MANUFACTURING

(71) Applicant: Carlsbad Safety Products, LLC, Carlsbad, CA (US)

(72) Inventor: Daniel A. MCROSKEY, Rancho Santa Fe, CA (US)

(21) Appl. No.: 15/339,407

(22) Filed: Oct. 31, 2016

Related U.S. Application Data
(60) Provisional application No. 62/251,213, filed on Nov. 5, 2015.

(51) Int. Cl. B29C 53/06; E06B 7/36

(52) U.S. Cl. CPC B29C 53/063; E06B 7/367; B29K 2027/06

(57) ABSTRACT

A door safety device generally includes a door attachment portion, a spanning portion, and a door jamb attachment portion. The spanning portion can be operatively coupled to the door (and/or door jamb) attachment portions by one or more living hinges, optionally with tambour portions disposed between the spanning portion and the door (and/or door jamb) attachment portios. The tambour portions can also include one or more living hinges. The living hinges can have a range of motion of less than 180 degrees, for example less than 175, 170, 165, or 160 degrees. A method of manufacturing a door safety device includes creating a score line along a surface of a substantially planar sheet of material, and snapping the sheet along the score line so as to create a hinge. The snapping creates a plastic deformation of the material in the region of the score line.

### CROSS-REFERENCE TO RELATED APPLICATIONS

This application claims the benefit of U.S. Provisional Application No. 62/251,213, filed Nov. 5, 2015, the disclosure of which is incorporated herein by reference in its entirety.

### BACKGROUND

Field of the Invention

This application relates to door safety devices and methods of manufacturing the same. More particularly, this application relates to devices for covering the gap between the door and the door frame or jamb at the hinged side of a door, and methods of making the same.

Description of the Related Technology

One of the most common household injuries to people, especially children, involves the crushing or mashing of fingers between the door frame and an edge or surface of a door. The most severe of such injuries tend to occur at the hinged side of the door. The resulting damage may include broken and shattered finger bones, and may even require finger amputations. Various prior art devices are directed at preventing such injuries, including shields designed to bridge the gap between the door and the door jamb.

### SUMMARY

In one aspect, a method of manufacturing a door safety shield comprises providing a substantially planar sheet of material, creating at least one score line along at least one surface of the sheet, and snapping the sheet along the at least one score line so as to create a hinge along the score line, wherein the snapping creates a plastic deformation of the material in the region of the score line. In an embodiment, the method further comprises repeating the creating and snapping steps. In various embodiments, the snapping creates a living hinge in the region of the score line, the living hinge having a range of motion of less than 175 degrees, less than 170 degrees, or less than 160 degrees.

### BRIEF DESCRIPTION OF THE DRAWINGS

These and other features, aspects, and advantages are described below with reference to the drawings, which are intended to illustrate, but not to limit, the invention. In the drawings, like reference numerals denote like features throughout various embodiments.

FIG. 1 illustrates a partially cut away perspective view of one example of a door safety device, configured in accordance with an embodiment.

FIG. 2 illustrates an end view of the door safety device of FIG. 1.

FIG. 3 illustrates steps in a method of manufacturing a door safety shield, in accordance with an embodiment.

FIG. 4A is a photograph illustrating an initially flat sheet of material after having been broken along a score line on one side of the sheet, in accordance with an embodiment.

FIG. 4B is a photograph of the sheet of material of FIG. 4A, showing a user attempting to flatten the sheet in the region of the score line and break.

FIG. 5A is a photograph of another initially flat sheet of material after having been broken along two score lines on one side of the sheet, in accordance with an embodiment, and shown in a resting or unstressed state.

FIG. 5B is a photograph of the sheet of material of FIG. 5A, showing a user attempting to flatten the sheet after the score lines have been broken.

FIG. 6 is a flowchart illustrating one method of manufacturing a door safety device, in accordance with an embodiment.

### DETAILED DESCRIPTION OF CERTAIN INVENTIVE EMBODIMENTS

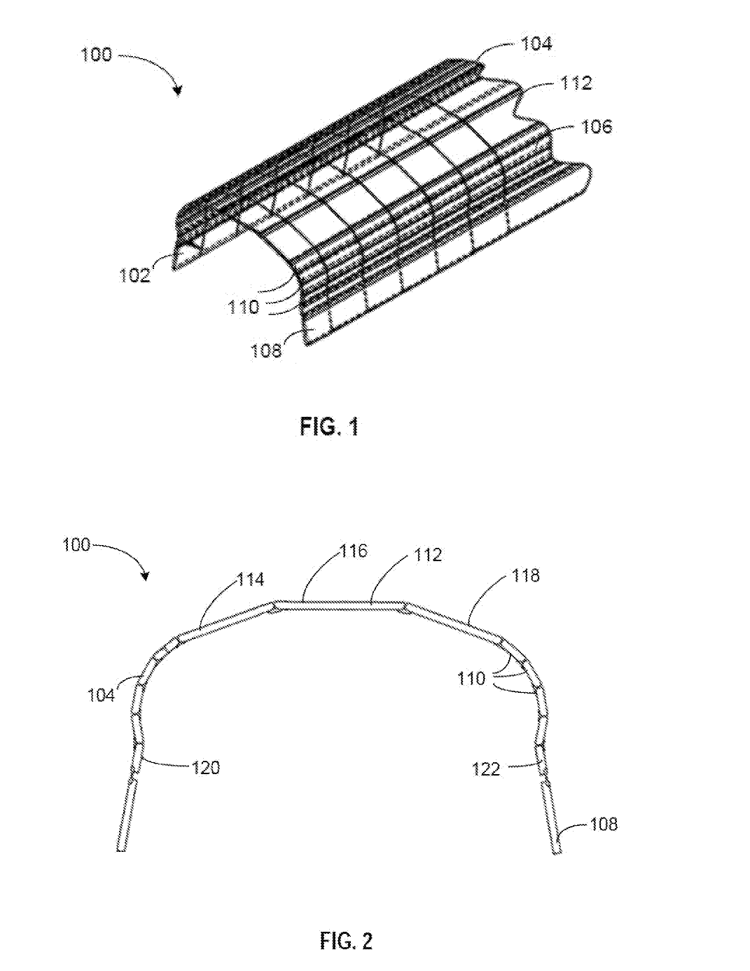

With reference now to FIG. 1, a door safety shield 100 according to an embodiment is illustrated. The safety shield includes a door attachment portion 102, a first tambour portion 104, a second tambour portion 106, and a door jamb attachment portion 108. The door attachment portion and the door jamb attachment portion can each be provided with an attachment member (not shown in), such as an adhesive layer or a layer of a hook-and-loop fastener, configured to allow attachment to surfaces of a door and door jamb, respectively. The first tambour portion and the second tambour portion each comprise a plurality of tambour slats 110 (also referred to as tambour panels) which are hingedly coupled to one another so as to be pivotable in one direction only (that is, within an arc of about 180, or slightly less than 180 degrees), such that the first tambour portion and the second tambour portion are each substantially flexible in one direction but substantially inflexible in the opposite direction. The tambour panels 110 are configured with a narrow enough width to allow the first and second tambour portions 104, 106 to move in a rolling fashion, at least when an external force is applied to some portion of the shield. The hinged couplings between adjacent tambour panels can also be configured with a somewhat limited flexibility or limited range of flexibility (such as, for example, a range of motion of 175 degrees, 170 degrees, 165 degrees, 160 degrees, 155 degrees, 150 degrees, or a smaller range of motion) so as to reduce or eliminate the risk of adjacent panels folding completely back against each other and locking up the rolling motion of the tambour portions.

The first tambour portion 104 can be coupled to the door attachment portion 102 by at least one coupling that is flexible in the opposite direction from the flexible direction of the tambour portions 110. In the embodiment illustrated in FIG. 1, the coupling between the first tambour portion and the door attachment portion comprises two hinges connected by a connecting portion 120. The hinges can be configured to be pivotable in one direction only (that is, within an arc of about 180 degrees, or slightly less than 180 degrees), that direction being opposite direction from the flexible direction of the tambour portions. In some embodiments, the hinges need not be configured with a limited range of motion.

The second tambour portion 106 is also coupled to the door jamb attachment portion 108 by at least one coupling that is flexible in the opposite direction from the flexible direction of the tambour portions 110. In the embodiment illustrated in FIG. 1, the coupling between the second tambour portion and the door attachment portion comprises two hinges connected by a connecting portion 122. The hinges can be configured to be pivotable in one direction only (that is, within an arc of about 180 degrees, or slightly less than 180 degrees), that direction also being opposite direction from the flexible direction of the tambour portions. In some embodiments, the hinges need not be configured with a limited range of motion.

The first and second tambour portions 104, 106 are operatively coupled by a spanning portion 112. The spanning portion can be configured with a length sufficient to, in combination with the first and second tambour portions, allow the shield to span the gap between a surface of a door and a surface of a door jamb, whether the door is in a closed, partially open, or fully open position, without creating substantial detaching forces on the door attachment portion 102 or the door jamb attachment portion 108. In the embodiment illustrated in FIG. 1, the spanning portion 112 includes three panels 114, 116, 118 which are hingedly coupled to one another and to the first tambour portion (on one end) and the second tambour portion (on the other end) so as to be flexible in the same direction as the flexible direction of the tambour portions. As the panels need not necessarily be configured to move in a rolling fashion like the tambour panels, the panels can be configured with any desired width, including widths larger than the width of the tambour panels. In some embodiments, the spanning portion can be configured to be substantially rigid, without movable sub-portions. In some embodiments, the spanning portion can be configured to be substantially planar. In other embodiments, the spanning portion can be curved.

FIG. 2 shows an end view of the shield 100 in a relaxed state, and illustrates the directionality of the hinged couplings between the door attachment portion 102, the connecting portion 120, the first tambour portion 104 and its component tambour slats 110, the spanning portion 112 and its component panels 114, 116, 118, the second tambour portion 106 and its component tambour slats 110, the connecting portion 122, and the door jamb attachment portion 108.

Embodiments such as those illustrated in FIGS. 1 and 2 can be configured to prevent a complete flattening of the device 100, so that even when adjacent tambour panels 110 are abutted against each other, the array of tambour portions 110 maintains at least a slight convex curvature. In embodiments having spanning portions including movable sub-panels, the sub-panels can be similarly configured. In embodiments having a rigid spanning portion, the spanning portion can also be configured with at least a slight curvature.

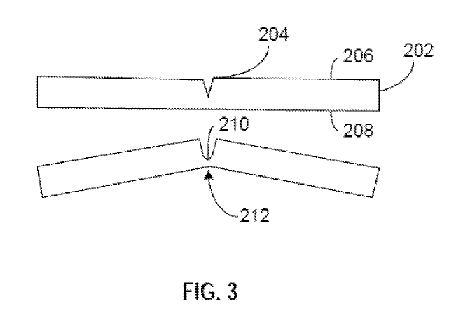

Turning now to FIG. 3, steps in a method of manufacturing a door safety shield 200 in accordance with an embodiment are illustrated. The method can begin with providing an initially flat sheet 202 of a rigid or semi-rigid material, such as, for example, a polyvinylchloride (PVC) foam board. In some embodiments, the sheet 202 can include a laminate, or a layer of a different material, on one or both surface, such as, for example, a paper backing layer 208. The method can then include creating at least one score line 204 in one surface 206 of the sheet. In the embodiment illustrated in FIG. 3, the score line 204 is created in the surface 206 opposite the backing layer 208. As can be seen in FIG. 3, the score line 204 is a cut that extends only partway through the thickness of the sheet 202. The method then includes bending the sheet 202 in the region of the score line 204, so that the material of the sheet 202 cracks or separates below the score line.

If the sheet comprises a brittle material, the crack or separation will be a relatively smooth fracture, likely extending through the full thickness of the sheet material. Such a clean break between opposing sides of the score line will either separate the two sides of the score line completely (for example where the sheet has no backing layer), or will create a living hinge which is capable of easily flexing through a full 180° arc (for example where the sheet has a backing layer), such that the sheet can easily return from a bent configuration to a flat configuration.

However, in embodiments, sheet materials which are configured to plastically deform somewhat before breaking can be employed to advantage to manufacture a door safety shield having a “resting” curvature, from an initially flat sheet of material. As illustrated in FIG. 3, by using a suitable sheet material, the step of bending the sheet 202 in the region of the score line 204 will cause the sheet material to stretch into the gap between opposing sides of the score line and undergo at least some plastic deformation 210 before finally yielding and breaking to form the hinge 212. The plastic deformation 210 of the adjacent sides of the sheet material along the fracture, below the score line, form abutments that inhibit or prevent the sheet from returning to a perfectly flat configuration in the region of the hinge. The resulting configuration is a three-dimensional door safety device 200 with “resting bends” in the device at the location of the hinges, and which resists being returned to a perfectly flat configuration.

In embodiments, the sheet can be scored on either or both surfaces in the desired locations of the hinges. The material can be a foam material, such as, for example, a closed-cell extruded polystyrene (XPS) foam or polyvinyl chloride (PVC) foam. The material can be selected to be rigid enough to resist dimpling, bending, or otherwise deforming upon application of direct force, but configured to exhibit some amount of plastic deformation before breaking upon being scored and bent along the score lines. Using such a material, scoring and then snapping the material will cause some of the material on either side of the score line to plastically deform into the space created at the break, creating a physical obstruction in the space and preventing the sheet from being pressed flat along the score line. The hinges can be configured with a slightly less-than −180° range of motion; for example, a 175°, 170°, 165°, 160°, 155°, 150°, or smaller range of motion.

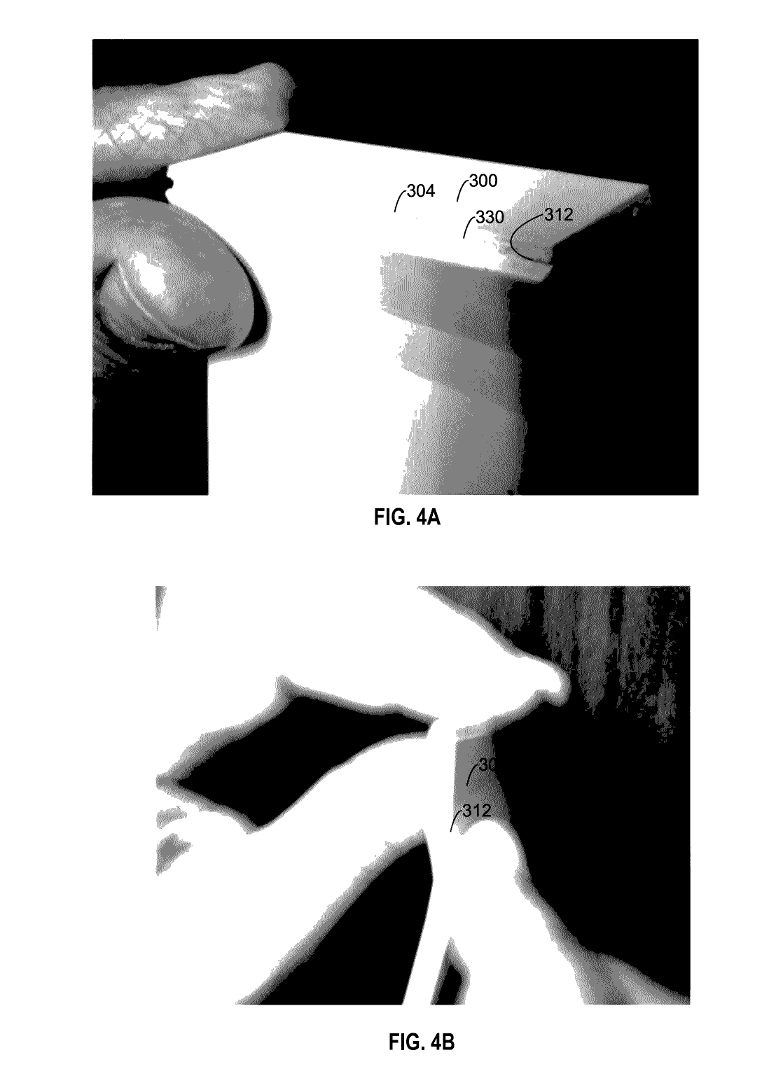

FIG. 4A is a photograph of one embodiment of a door safety device 300, showing a sheet of laminated foam material after having been scored along one surface and then bent along the score line 304 to create a living hinge 312. As can be seen in FIG. 4A, the score line 304 itself is a smooth cut that extends only a short distance through the thickness of the sheet. The break 330 below the score line 304, however, is a rough break, with some material from either side of the score line having been pulled into the gap during the break.

FIG. 4B is a photograph of the embodiment of FIG. 4A, with the hinge 312 of FIG. 4A being bent back into an open position. As can be seen in FIG. 4B, due to the obstruction created by the rough break 330 (e.g., by material that was pulled into the gap during the creation of the hinge 312), the device 300 now resists being pressed back into a completely flat configuration in the region of the hinge 312.

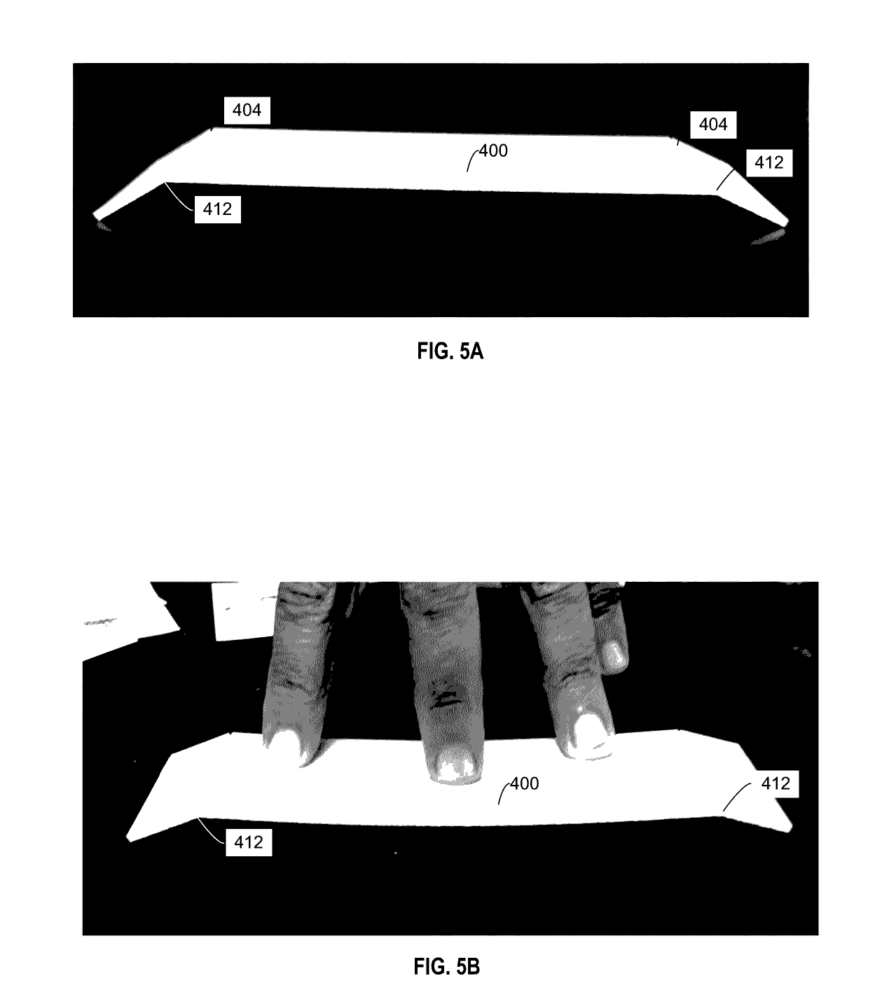

FIG. 5A is a photograph of another embodiment of a door safety device 400, showing a sheet of laminated foam material after having been scored twice along one surface and then bent along each score line 404 to create living hinges 412 in the regions of the score lines. The material is selected to undergo at least some plastic deformation upon being bent and cracked along the score lines, creating obstructions that inhibit or prevent the hinges 412 from returning to a flat configuration. As can be seen in FIG. 5A, with no pressure applied to the device 400 at all, the device has a “resting” bend at the location of each hinge 412. Thus, in accordance with embodiments, a three-dimensional door safety device can be formed from an initially two-dimensional sheet.

FIG. 5B is a photograph of the embodiment of FIG. 5A, shown with a direct force being applied to the shield 400 in between the two hinges 412. As can be seen in FIG. 5B, due to the obstruction created by plastic deformation of the sheet material during the creation of the hinge 412, the device 400 now resists being pressed back into a completely flat configuration in the region of the hinge.

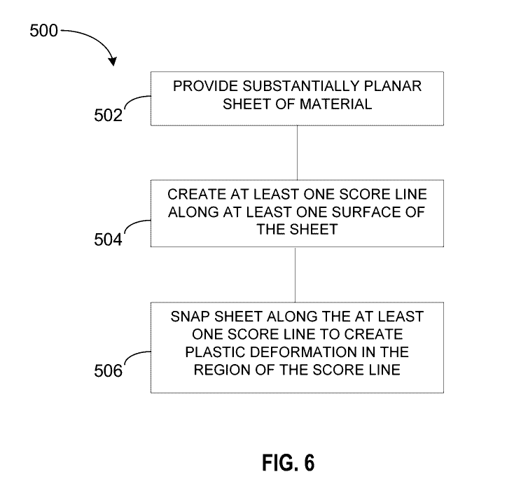

FIG. 6 is a block diagram illustrating one method 500 of manufacturing a door safety device in accordance with an embodiment. At the first block 502, a substantially planar sheet of material is provided. At the second block 504, at least one score line is created along at least one surface of the sheet. At the third block 506, the sheet is snapped along the at least one score line, without completely separating the two sides of the score line, to create plastic deformation in the sheet in the region of the score line. By selecting a material which is substantially rigid and resistant to impact, but which exhibits some degree of plastic deformation upon scoring and breaking, a three dimensional shield than thereby be produced with a desirable degree of resting curvature in its hinges, from an initially two-dimensional sheet.

A variety of material properties can be used to select a material exhibiting a suitable level of plastic deformation upon scoring and breaking. For example, in some embodiments, material properties such as density, modulus of elasticity, and yield strength can be selected to achieve a desirable level of plastic deformation for a particular application. For example, in some embodiments, a foam material having a density between 0.3 g/cm³ to 0.65 g/cm³, or more particularly, a density of about 0.4 g/cm³ to 0.6 g/cm³ can be used. Further, in some embodiments, a foam material incorporating a particular ingredient or component, such as a foam material including a high calcium carbonate content can be used to promote plastic deformation upon breaking.

Some extruded foam sheets have directionally-dependent properties; e.g. a particular material might exhibit more plastic deformation upon breaking when scored in the direction of extrusion than when scored in a perpendicular direction, or vice versa. In some embodiments, such directional dependence can be utilized to advantage in a method for manufacturing a door safety shield with a desirable degree of resting curvature in its hinges.

In addition or in the alternative, the dimensions of the cutting blade used for scoring, and/or the cutting depth, can be varied to promote a desirable degree or extent of plastic deformation upon breaking.

In some embodiments, the shield can be formed from layer of a first material which is adhered to (or otherwise affixed to) a backing layer comprising a flexible material, such as a sheet of fabric, plastic, or paper. The first material can be selected to exhibit a desirable degree of plastic deformation upon scoring/breaking, so as to create a living hinge with a desirable degree of resting curvature. The first material can be scored on the side opposite the backing layer, and then the layers can be rolled to break the scores and separate the first material into a series of closely-abutting panels.

In both the closed and open positions, the particular hinged configuration of the door attachment portion and the door jamb attachment portion, the tambour portions, and the spanning portion serves to limit and/or direct the transfer of forces between these panels, thereby limiting the transfer of potential detachment forces to the door attachment portion and the door jamb attachment portion. Such a configuration is particularly desirable in embodiments in which the shield is attached to the door and/or door jamb by a less permanent form of attachment than, for example, screws, such as an adhesive or hook-and-loop attachment.

Similarly, the hinge points between each portion of the shield can have any suitable construction which provides the desired range of motion for the particular hinged portions. For example, some or all of the hinge points can be formed in a similar manner as the articulations described above, taking into account the desired direction or range of flexibility of the hinged portions as described herein. Further, although the illustrated embodiments include shields configured for attachment to a surface of a door stop which extends generally parallel to a surface of a door in the closed position, embodiments can of course be configured for attachment to other surfaces of the door jamb, with hinge points adjusted to facilitate (or limit) the desired (or unwanted) flexibility and/or range of motion as described herein. Embodiments of the invention also include methods of manufacturing a safety shield generally as described herein.

In addition, shields according to embodiments of the invention can be configured for any suitable manner of attachment to a door and door jamb. For example, the door edge attachment portion and/or the door jamb attachment portion can be configured with an adhesive layer or a hook-and-loop fastener strip for removable or semi-permanent attachment to their respective surfaces on the door and door jamb. Of course, if desired, embodiments can be configured for more permanent attachment, for example with screws. Because the door attachment portion is configured for attachment to an edge of the door, more permanent attachment will not mar the face of the door. The configuration of the shield facilitates such attachment, as the door edge attachment portion can be affixed to the edge of the door (with free access to the gap) prior to the door jamb attachment portion being affixed to the door jamb. Further, although the illustrated embodiments show the door jamb attachment portion being affixed to a surface of a door stop which extends substantially parallel to a surface of the closed door, embodiments can also be configured for attachment to a surface of a door jamb extending normal to a surface of a closed door. In such an embodiment, any superfluous hinges can be omitted.

While the above detailed description has shown, described and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. Therefore, it should be clearly understood that the forms of the invention described herein are illustrative only and are not intended to limit the scope of the invention.

What is claimed is:

1. A method of manufacturing a door safety shield, the method comprising:
providing a substantially planar sheet of material;
creating at least one score line along at least one surface of the sheet; and
snapping the sheet along the at least one score line so as to create a hinge along the score line, wherein the snapping creates a plastic deformation of the material in the region of the score line.

2. The method of claim 1, further comprising repeating the creating and snapping steps.

3. The method of claim 1, wherein the snapping creates a living hinge in the region of the score line, the living hinge having a range of motion of less than 175 degrees.

4. The method of claim 1, wherein the snapping creates a living hinge in the region of the score line, the living hinge having a range of motion of less than 170 degrees.

5. The method of claim 1, wherein the snapping creates a living hinge in the region of the score line, the living hinge having a range of motion of less than 160 degrees.
